(19) United States
(12) Patent Application Publication
(10) Pub. No.: US 2010/0001110 A1
(43) Pub. Date: Jan. 7, 2010

(54) MATERIAL BREAKER

(75) Inventor: Ronald H. Tschantz, Malvern, OH (US)

Correspondence Address: SAND & SEBOLT, AEGIS TOWER, SUITE 1100, 4940 MUNSON STREET, NW, CANTON, OH, 44718-3615, US

(73) Assignee: IMPERIAL TECHNOLOGIES, INC., Canton, OH (US)

(21) Appl. No.: 12/491,754

(22) Filed: Jun. 25, 2009

Related U.S. Application Data
(60) Provisional application No. 61/133,929, filed on Jul. 3, 2008.

(51) Int. Cl. B02C 9/04

(52) U.S. Cl. 241/165.5

(57) ABSTRACT

A material breaker for breaking larger lumps of material into smaller pieces. The breaker includes at least a first, second and third processing region arranged in series. Each of the processing regions includes an inclined scalping grizzly, a rotor and an impact grid. Large lumps of material move down the scalping grizzly, are engaged by the rotor and accelerated toward the impact grid where they are fractured. The scalping grizzlies and impact grids have openings therein through which pieces of a predetermined desired size and smaller may pass without further engagement in the breaking process. The rotor speeds are sufficiently low enough to enable the larger lumps of desirable material to break into the predetermined size without producing excessive particulates or generating large quantities of dust.

### CROSS REFERENCE TO RELATED APPLICATIONS

This application claims priority from U.S. Provisional Application Ser. No. 61/133,929 filed Jul. 3, 2008; the disclosure of which is incorporated herein by reference.

### BACKGROUND OF THE INVENTION

1. Technical Field

This invention generally relates to equipment in the materials processing industry and in particular to a device which breaks mined material into a predetermined desired size range. More particularly, the invention relates to equipment in which larger lumps of material are fractured and broken into smaller pieces by accelerating the material and impelling it against breaker bars. Specifically, the invention relates to a device in which the material is passed through three or more processing regions, where each region includes an inclined surface along which the material travels, a variable speed rotor for accelerating the material in the direction it was traveling and a breaking surface for fracturing the material into smaller pieces.

2. Background Information

Mined materials comprise a mixture of rocks and minerals. This presents a problem to a materials processor in that they need to separate the desired materials from the non-desired materials. In the coal mining industry, for example, the mined material will include a quantity of coal and a quantity of rock. The rock, which cannot burn, is regarded as an impurity that needs to be separated from the coal before it can be sold. The actual quantity of impurities in any given sample of mined material may vary from a reasonably small fraction to a substantial fraction. It is necessary to process the mined material in such a way as to be able to separate the desired material from the impurities in the most efficient and cost effective manner. Furthermore, depending upon the final use for which the desired material is intended, it may be necessary to break larger lumps of the material into smaller pieces of a predetermined size range. For example, pieces of coal that are two inches in diameter and smaller are commonly used in many burning applications. Consequently, if the mined material includes coal lumps that are greater than two inches in diameter, it would be necessary to break those larger coal lumps down to the desired size range of two inches and smaller.

Materials processors have utilized a variety of methods to break down larger lumps of mined material into a desired size range and to separate the desired material from the impurities. These methodologies have included attrition, where the larger material lumps are scrubbed between two opposing hard surfaces, shear where smaller sections of larger material lumps are broken off, compression where the larger material lumps are crushed between two surfaces, and impact where the larger material lumps are forced to collide with an object in order to break it up.

A variety of different machines have been developed that employ these methodologies in various combinations. Such machines have included rotary roller crushers in which the mined material is passed between and is crushed by counter-rotating rollers. Rotary breakers have also been used. These machines include a large, hollow rotating drum that includes a plurality of interior baffles to break up the material lumps as they are tumbled within the drum. Hammer mills have also been employed for crushing materials. Hammer mills include a hammer-type device that impacts the mined material resting on a surface and crushes the same. All of these prior art devices process the desired material and the impurities in the same manner and substantially to the same degree. Consequently, larger lumps of both the desired material and the impurities are broken down into smaller pieces by the machinery and it therefore becomes more difficult to separate the desired material from the impurities by size and further processing is required.

Furthermore, these previously known machines are typically located at a material wash plant which may be some distance from the mine or pit. All of the mined material, which contains both the larger material lumps and the impurities, must be transported from the mine to the processing site. After processing, the removed impurities must either be returned to the original site or be transported to a disposal site. Wet processing of material exacerbates handling issues and creates a variety of environmental concerns. All of these issues increase the cost of recovering the desired material.

While all of these previously known breakers perform satisfactorily, they require a considerable amount of energy to rotate the crusher rolls, to rotate the drum or operate the hammer-type device. Furthermore, it is difficult to adjust the machinery to cause different size material pieces to be produced. It is also difficult to correlate the breaking force produced by the machine to the hardness of the particular seam of material being broken down by the equipment.

In addition to the previously discussed equipment, several types of material breakers employ rotors which propel the lumps of mined material against impact surfaces in order to break the larger lumps into smaller pieces. Examples of these types of breakers are shown in U.S. Pat. Nos. 2,110,850 and 2,192,606. Although these breakers perform satisfactorily, they require a relatively large motor and increased power because of the heavy structural members utilized therein and because the rotors are used to change the direction of the material lumps being broken down. In addition to propelling the material lumps and increasing the speed thereof for impact against a surface, the rotor blades are also used to perform some crushing or shearing of the material lumps. The previously known machines also do not remove the desired size material pieces from the processing flow of the machine as soon as possible after production thereof. Consequently, both the larger and smaller sized material pieces tend to remain in the breaker for a longer period of time. This tends to result in an increased quantity of the desired size pieces being further reduced in size, thereby reducing the quantity of saleable product. Additionally, the over-processing of the material increases the quantity of small particles or particulates that are produced by the equipment. In the coal processing industry these particulates are known as fines. Fines are typically more difficult to process and handle and the production of excessive quantities of the same is undesirable.

This issue was addressed in U.S. Pat. No. 4,592,516. This patent is assigned to the present assignee and the entire specification thereof is incorporated herein by reference. The patent discloses a device for breaking larger coal lumps into predetermined size coal pieces and separating those desired size pieces from the rock fraction before the coal is over-processed and broken down into fines.

The mined material is introduced into a hopper at the top of the machine and travels down a zigzag pathway. Along the pathway, the larger lumps of mined material are broken down by accelerating them and impacting them against appropriately positioned components. The pathway includes a first inclined scalping grizzly positioned proximate a first rotor. The rotor engages the larger lumps in the same direction in which they were traveling through the machine and accelerates them so that they strike against a first impact grid. Coal is typically softer and more friable than the rock fraction of the mined material. Consequently, when larger lumps of material strike the first impact grid the coal tends to fracture but the harder rock does not. Smaller pieces of coal break off the larger lumps when the larger lumps impact the first impact grid. The harder rock pieces tend to stay intact. The first impact grid includes a plurality of openings that allows coal pieces of a predetermined size and smaller to pass therethrough.

The portion of the mined material that did not pass through the openings in the first impact grid drops onto the inclined second scalping grizzly. Since the second scalping grizzly also contains openings therein, pieces of coal and rock that are of the predetermined size and smaller that did not pass through the openings in the first impact grid pass through the openings in the second scalping grizzly. This occurs before the smaller coal pieces encounter a second rotor. The desired size pieces of material are therefore removed before they can be accelerated into a second impact grid. This effectively prevents the desired size coal pieces from being further processed and broken down into fines.

Any larger pieces of the mined material that are unable to pass through the openings in the second scalping grizzly continue down the same and encounter the second rotor. The second rotor engages these pieces of material and propels them against the second impact grid. Once again, smaller pieces of coal are fractured off the larger lumps, while the rocks remain relatively unbroken. The second impact grid includes openings that allow any materials that are of the predetermined size and smaller to pass therethrough. The mined material that did not pass through any openings in either of first and second scalping grizzlies and first and second impact grids drops through a discharge opening at the base of the machine and exits the machine. Likewise, the predetermined size coal pieces and rocks that passed through the openings in the first and second grizzlies and first and second impact grids are also discharged from the machine. The discharged material is then screened to recover the desired size coal pieces.

In the device disclosed in U.S. Pat. No. 4,592,516, the speed of the rotors is adjusted to suit the hardness of the coal being processed. Harder coals require relatively higher rotor speeds to break up the coal lumps than do softer coals. For example, a hard coal may require a rotor speed of around 400-420 rpm to break the coal into smaller pieces, while a softer coal may only need a rotor speed of around 200-350 rpm.

While the device disclosed in U.S. Pat. No. 4,592,516 functions extremely well in some applications, it has been found that problems arise when larger lumps of material must be processed by the machine or when a smaller end product is desired. If the lumps are larger, the first and second rotors have to be rotated at a much higher rotor speed than would be warranted if the lumps were smaller. These higher rotor speeds have the undesirable side effect of shattering a greater percentage of the desired material into particulates. Additionally, a greater percentage of the impurities are broken down into a size that will pass through the openings in the scalping grizzlies and impact grids. Thus, the end product contains a lower quantity of the desired size material, a higher quantity of particulates and a higher quantity of impurities. The end product is therefore less saleable. This problem is exacerbated even further if the material is relatively hard.

An additional problem caused by rotating the rotors at higher speeds is that the production of additional particulates in combination with the air flow generated by the rotors tends to result in a large quantity of dust being blown out of the machine and into the surrounding area.

Accordingly, there is a need in the art for an improved material breaker that is able to break down larger sized lumps of material into pieces of a predetermined smaller size while producing fewer particulates and generating less dust than in previously known machines.

### SUMMARY OF THE INVENTION

The device of the present invention comprises a material breaker for breaking larger lumps of material into a smaller saleable product. The device processes these larger material lumps in a manner that tends to produce a fewer particulates and less dust. Additionally, the device and method tends to break down the large lumps of material without breaking down an increased percentage of impurities that would contaminate the end product. Furthermore, the device is designed to be operated at any location, but is most desirably operable at the mine or point of material generation itself, thereby reducing the costs involved with transporting undesirable impurities.

The breaker of the present invention includes a series of processing regions for splitting large diameter material lumps into pieces of a greatly reduced size. Specifically, the system includes three or more processing regions that are disposed in series with each other. In a first embodiment of the system, the three or more processing regions are disposed vertically one above the other. In a second embodiment of the system, the individual processing regions are linked to each other by way of conveyors or other transport mechanisms and may be disposed vertically relative to each other or horizontally relative to each other.

In accordance with one of the specific features of the present invention, each of the processing regions includes an inclined scalping grizzly, a rotor and an impact grid. All of the scalping grizzlies and impact grids have a plurality of openings therein through which pieces of the predetermined desired size may pass. The rotor in each processing region engages the lumps that are on the scalping grizzly and accelerates them toward the impact grid. When the larger lumps of material strike the impact grid, they are fractured and smaller pieces of the material break off the larger lumps.

In accordance with the present invention, the speeds of the first, second and third rotors are substantially reduced relative to previously known devices for processing materials of like nature. More specifically, the speeds of the first, second and third rotors are substantially reduced relative to the two rotors utilized in the machine disclosed in U.S. Pat. No. 4,592,516 for processing materials of like nature. The lower speeds are made possible by the presence of the additional processing regions that present extra opportunities for the larger lumps of material to be fractured. These substantially lowered speeds result in a higher yield of the desired size material pieces than in previously known machines. Additionally, the lower speed of rotation of the rotors results in a decrease in the quantity of particulates or fines produced and a decrease in the quantity of impurities of a size that can pass through the openings in the scalping grizzlies and impact grids. The device therefore produces a higher quality end product. Additionally, the system produces less dust than previously known machines because the rotors are rotating at lower speeds.

In the device of the present invention, the range of speed of operation of the first rotor in the first processing region is lower than would be the case if the system only included the two processing regions with two rotors disclosed in U.S. Pat. No. 4,592,516. By way of example only, the speed of the first rotor could be set at anywhere in the range of between 200 rpm and 250 rpm depending on a variety of factors. It will be understood that the rotor speed is set according to the nature of the mined material being processed in the breaker. So, for example, the speed of the first rotor would be set lower for softer materials and higher for harder materials. The rotor speed would also be determined by the size of the large lumps of material that are to be introduced into the first processing region and the desired end size of the materials being processed. So, for example, if the large lumps of material are to be broken down into a 1″ diameter size, then the speed of the first rotor might have to be set higher than would be the case if the size of the end product was to be 2″ in diameter or smaller.

Similarly, by way of example only, the speed of the second rotor in the second processing region could be set in the range of between 250 rpm and 300 rpm, and the speed of the third rotor in the third processing region could be set at somewhere between 300 rpm and 350 rpm.

Another objective of the invention is to provide a device in which the rotors are rotated at a speed sufficient not to accelerate the larger lumps of material at a velocity that will cause them to shatter in such a way as to produce excessive fines. Instead, the rotors are rotated at a speed sufficient to accelerate the large lumps of material at a velocity that will cause them to fracture in such a way as to maximize the desired size range of material pieces while producing a smaller quantity of fines.

A further objective of the invention is to provide such a construction in which the motors for driving the accelerator rotors are variable speed rotors that permit the speed to be adjusted depending on the hardness and friability of the material that is being split and sorted at a particular time. This variability enables more accurate control of the impact breakage effect of the improved device by a convenient adjustment of controls located on an electrical or hydraulic control panel.

Another objective of the invention is to provide such a material breaker construction in which the material, upon being reduced to the desired size range, is removed as soon as possible from within the system. This eliminates further breakage of the material and thereby reduces the quantity of fines that was common in prior breaker and crusher constructions.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a side elevational view of a material breaker and sorting device in accordance with the present invention;

FIG. 2 is a side view of an accelerator rotor utilized in the material breaker device of FIG. 1 shown removed from the hopper;

FIG. 3 is a front view of the accelerator rotor taken through line 3-3 of FIG. 2;

FIG. 4 is a left-hand elevational view of the scalping grizzly of FIG. 1 shown removed from the hopper;

FIG. 5 is a plan view of the scalping grizzly shown in FIG. 4;

FIG. 6 is a left-hand view of the impact grid;

FIG. 7 is a plan view of the impact grid removed from within the hopper;

FIG. 8 is a side elevational view of the impact grid;

FIG. 9 is a side view of the material breaker in use.

### DETAILED DESCRIPTION OF THE INVENTION

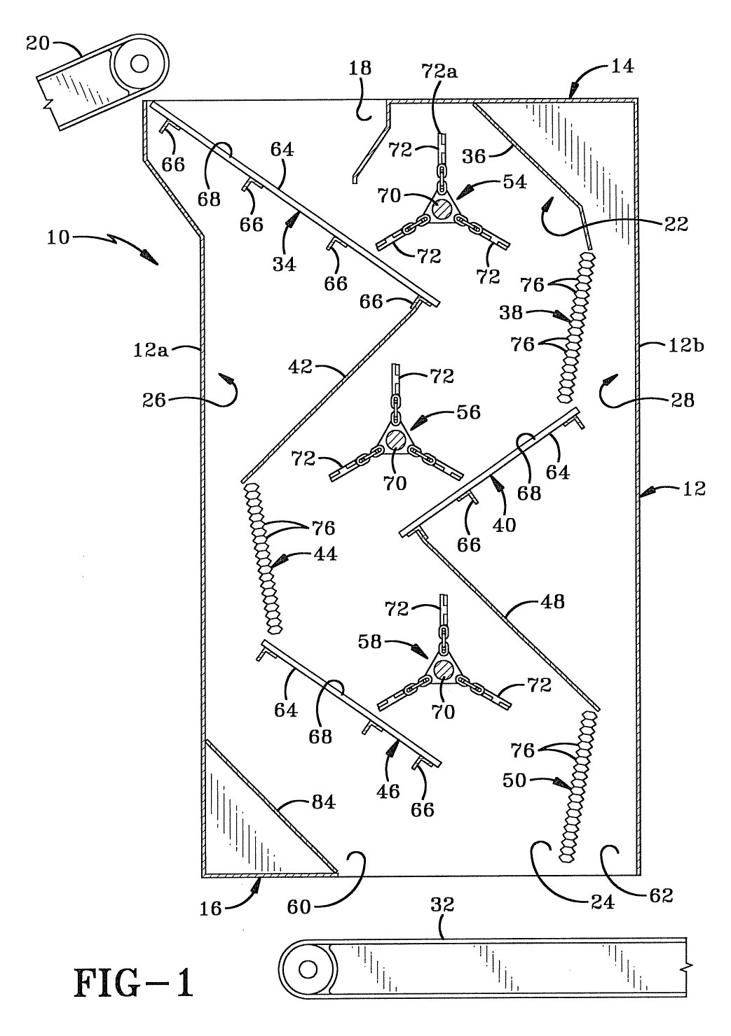

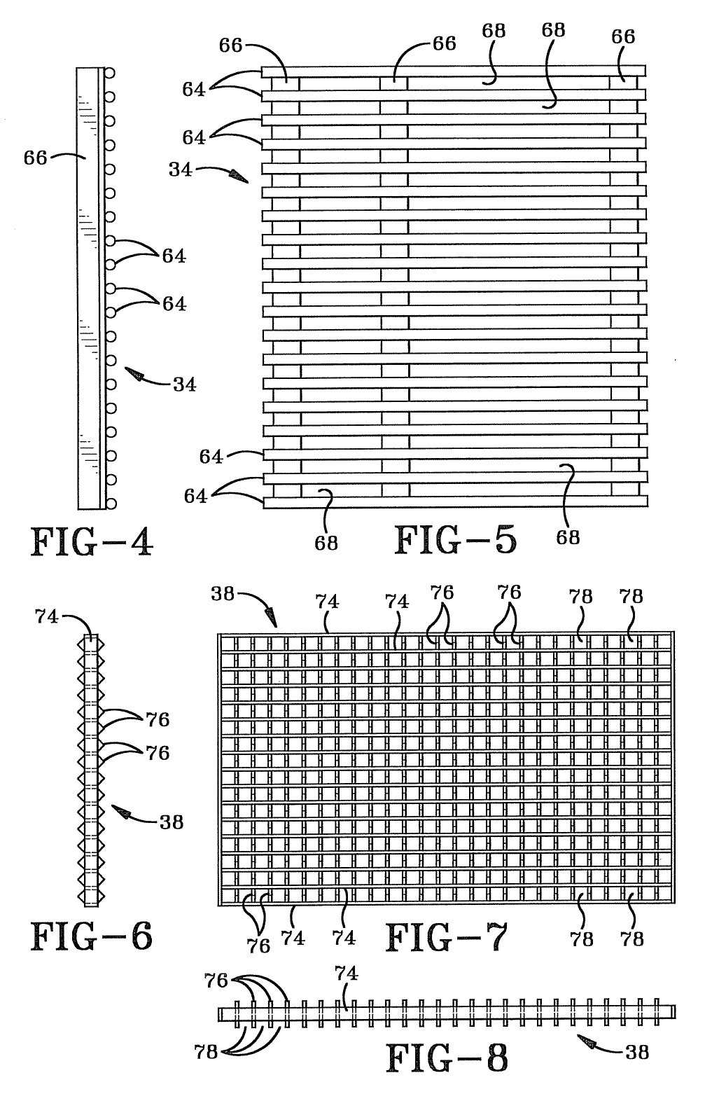

Referring to FIGS. 1-9, there is shown an improved material breaker in accordance with the present invention. Breaker comprises a hopper, generally indicated at 10, formed with a plurality of sheet metal side walls 12, a front and a rear wall (unnumbered), a top wall 14 and a bottom wall 16. Top wall 14 includes a top inlet opening 18 through which mined material, which includes the desired material, is introduced. Hopper 10 is positioned so that inlet opening 18 is disposed proximate a mined material delivery device such as a conveyor 20. Hopper 10 includes a zigzag passageway 22 formed therein. Passageway 22 extends from adjacent top wall 14 through to bottom wall 16. Mined material introduced through inlet opening 18, travels through passageway 22 for processing and any material left over after processing exits passageway 22 through a discharge opening 24.

Passageway 22 includes a first inclined scalping grizzly 34, a first inclined metal plate 36, a first impact grid 38, a second inclined scalping grizzly 40, a second inclined plate 42, and a second impact grid 44. A first accelerator rotor 54 is provided in passageway 22 proximate first scalping grizzly 34 and a second accelerator rotor 56 is provided in passageway 22 proximate second scalping grizzly 40. The breaker disclosed in U.S. Pat. No. 4,592,516, included these components.

In accordance with a specific feature of the present invention, passageway 22 further includes, a third processing region in which the mined material is further broken down into smaller size pieces. The third processing region includes a third inclined scalping grizzly 46, a third metal plate 48, and a third impact grid 50. In accordance with a further feature of the present invention, a third accelerator rotor 58 is provided in passageway 22 proximate third scalping grizzly 46. Although not illustrated in FIGS. 1-9, it will be understood by those skilled in the art that additional processing regions may be included in the material breaker disposed after the third processing region. Each of these additional processing regions would include a scalping grizzly, a rotor and an impact grid to further process the material traveling through the machine and to thereby reduce the size of the pieces of the desired material.

Referring still to FIGS. 1-9, a first chute 26 is formed between sidewall 12a, first scalping grizzly 34, and second plate 42, second impact grid 44 and, third scalping grizzly 46. The front and rear walls of hopper 10 complete the first chute 26. A first discharge opening 60 is formed at the lowermost end of first chute 26. A second chute 28 is formed between sidewall 12b, first plate 36, first impact grid 38, second scalping grizzly 40, third plate 48 and third impact grid 50. The front and rear walls of hopper 10 complete second chute 28. A second discharge opening 62 is formed at the lowermost end of second chute 28. Passageway 22 may also include a fourth metal plate (not shown) extending downwardly from third scalping grizzly 46 to separate passageway 22 and first chute 26 and thereby aid in directing material from passageway 22 and through discharge opening 24. During processing, pieces of the desired material and impurities that are of the predetermined desired size pass into one of the first and second chutes 26, 28. Chutes 26, 28 ultimately discharge through discharge opening 24 onto any one of a conveyor 32, a screen (not shown), a hopper (not shown) or a pile (not shown). The discharged material may be screened or further processed as necessary to remove the impurities and to recover the desired material of a predetermined size and smaller.

Each of the first, second and third scalping grizzlies 34, 40 and 46 are substantially identical in structure and function. First scalping grizzly 34 is shown by way of example in FIGS. 4 & 5. First scalping grizzly 34 comprises a plurality of longitudinally extending, spaced bars 64 connected by cross members 66. The spaces between bars 64 define a plurality of predetermined size openings 68. Openings 68 enable the desired size of pieces to pass through the scalping grizzly 34 and fall into first chute 26. Similarly, the desired size material pieces pass through openings 68 in second scalping grizzly 40 into second chute 28 and pass through openings 68 in third scalping grizzly 46 and into first chute 26. Scalping grizzlies 34, 40 and 46 enable material pieces of the desired size to fall directly through the openings 68 and be directed by first and second chutes 26 and 28 to exit the machine without passing through the impact mechanism described in detail hereinafter. This eliminates further breaking of the correctly sized material pieces to an excessively small and undesirable size.

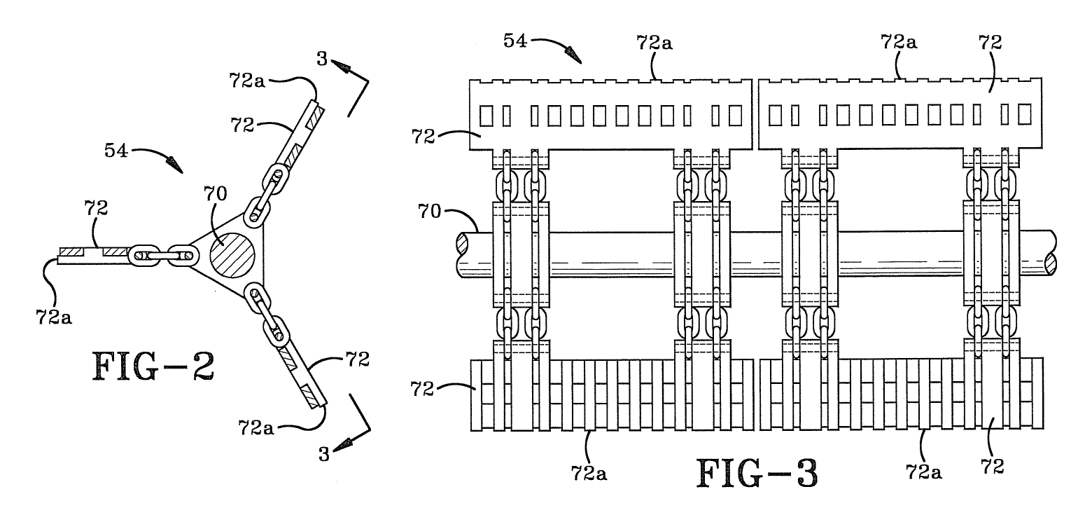

Each of the first, second and third rotors 54, 56 and 58 are substantially identical in structure and function and the speed of each rotor may be varied as necessary to break down the mined material. First rotor 54 is shown by way of example in FIGS. 2 & 3. First rotor 54 is mounted within passageway 22 adjacent the lower end of inclined first scalping grizzly 34 and includes a shaft 70 which extends horizontally between the front and rear walls of hopper 10. Rotor 54 is rotatably mounted by bearings mounted on support members attached to the outside surface of said front and rear walls. A plurality of equally spaced flails 72, preferably three in number, are mounted on shaft 70 and extend radially outwardly therefrom. A motor (not shown) mounted on a bracket attached to the rear wall of hopper 10 drives first rotor 54. The first scalping grizzly 34 is mounted at an angle of around 35 degrees to a horizontal plane and is arranged so as to be generally tangential to the circular periphery defined by rotating flails 72 on first rotor 54. Flails 72 are of such a length that the tips 72a terminate proximate first scalping grizzly 34 and will pass just above first scalping grizzly 34 as first rotor 54 rotates. This arrangement enables any material lumps and pieces and any rocks and minerals mixed therein rolling downwardly along first scalping grizzly 34 to be struck by flails 72 and propelled in the same direction that they were traveling. Similarly, second rotor 56 is positioned proximate the lowermost end of second scalping grizzly 40 and third rotor 58 is positioned proximate the lowermost end of third scalping grizzly 46.

The first, second and third impact grids 38, 44 and 50 are all substantially identical in structure and function. First impact grid 38 is shown by way of example in FIGS. 6-8. First impact grid 38 is formed by a plurality of longitudinally extending spaced bars 74 and a plurality of pointed insert plates 76 which define openings 78 therebetween. Openings 78 are similar in size to the width of openings 68 in first scalping grizzly 34. This size corresponds to the desired material particle size to be obtained from breaker. Pointed insert plates 76 assist in breaking and splitting the larger material lumps as the material is impacted against first impact grid 38. First impact grid 38 is mounted on an outwardly swinging portion of the front wall of hopper 10 so that it may be more easily flipped over as the points on insert plates 76 become worn down, and so that it can be easily replaced when the points on both sides thereof have become too worn to function properly. The material pieces of the desired size will pass through the openings 78 and into the upper end of second chute 28. Successive impact grids are substantially identical in structure and function to first impact grid 38.

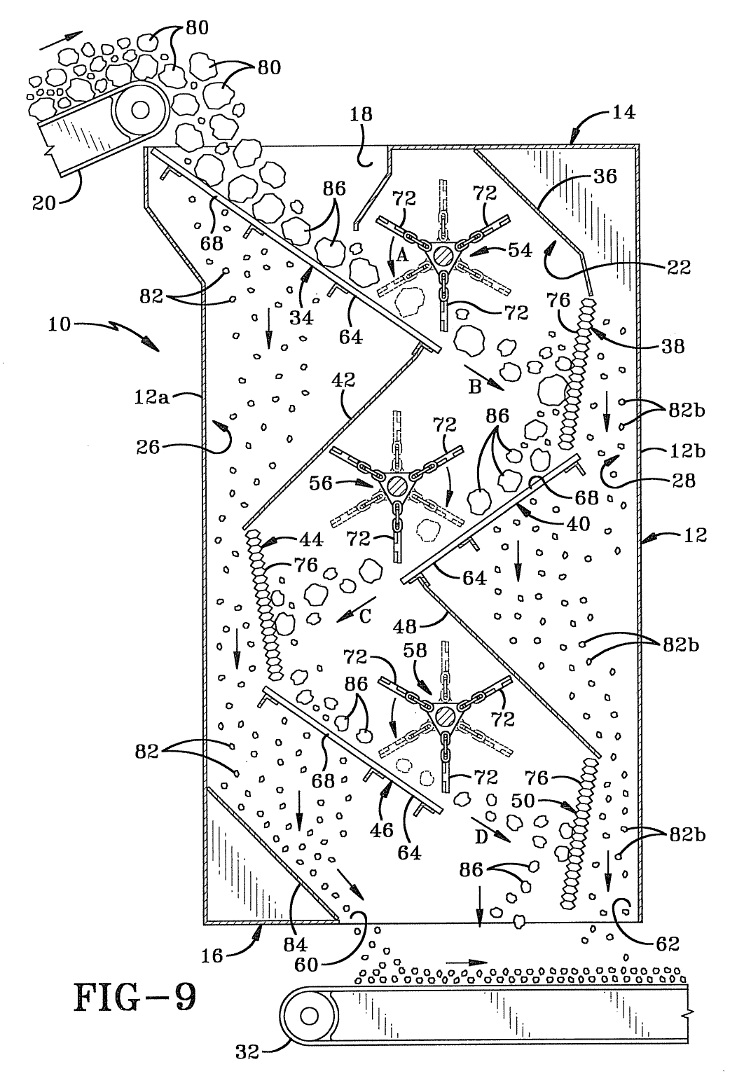

The operation of improved material breaker is best understood by reference to FIG. 9. A supply of material 80 is deposited by a conveyor 20 or some other method into inlet opening 18 in upper wall 14 of hopper 10 and passes into the first processing region. Material 80 includes larger and smaller lumps of material, rocks and minerals. Specifically, material 80 includes larger material lumps 86 that are greater than 2″ in diameter. It will be understood that the breaker could be constructed so as to process lumps of material that are substantially larger than 2″ into smaller pieces of material that are 2″ in diameter or less. If practical and economically feasible, the breaker could be constructed to process lumps of material that are anywhere up to 18″ in diameter or larger and to break those large lumps into pieces that are 2″ in diameter or smaller.

In the breaker, the material 80 passes from conveyor 20 onto first scalping grizzly 34 of the first processing region and then moves down the inclined grid 34 under the influence of gravity. Any material pieces and impurities of a size smaller than the openings 68 in first scalping grizzly 34, such as pieces 82, will pass through openings 68 in first scalping grizzly 34 and into first chute 26. Pieces 82 fall downwardly through first chute 26 until they contact plate 84 at the base of hopper 10. Plate 84 directs pieces 82 through discharge opening 24 and onto conveyor 32. (It will be understood, that instead of conveyor 32, a screen or hopper could be positioned beneath discharge opening 24. Alternatively, the discharged material could simply drop onto the ground beneath the breaker. ) This immediate removal of predetermined size pieces 82 from the first processing region prevents them from being further reduced in size.

The remaining larger material lumps 86 and any impurities present that are too large to pass through openings 68 continue to roll down inclined first scalping grizzly 34. First rotor 54 is rotating in the direction indicated by the arrow A. When flails 72 contact lumps 86, the lumps 86 are caused to accelerate in generally the same direction in which they were traveling down first scalping grizzly 34, i.e., in the direction of travel indicated by arrow B. This propulsion in the same direction requires considerably less power for operating first rotor 54 than if the material lumps were struck by a rotor which changed the particle's direction of travel. The accelerated material lumps 86 impact first impact grid 38 and are split by pointed plates 76. Any pieces that are of a size that enables them to pass through openings 78 (FIG. 7), do so. These pieces 82b pass into second chute 28 and travel downwardly until they drop through discharge chute 24. Once again, this immediate removal of desired size pieces 82b prevents them from being further processed and therefore being reduced in size.

The remaining materials including material lumps 86 and impurities pass from the first processing region into the second processing region by dropping from the first impact grid onto inclined second scalping grizzly 40. Once again, if any of the predetermined sized pieces 82b and smaller are present in these mined materials, they pass through openings 68 in second scalping grizzly 40 and into second chute 28. The remaining larger material lumps 86 and impurities are struck by flails 72 of second rotor 56 and are accelerated in the same direction in which they were traveling, i.e., in the direction of arrow C. The accelerated material lumps 86 and impurities are thrown against second impact grid 44 and are split by pointed plates 76 thereon. Many of the predetermined sized pieces 82 pass through openings 78 (FIG. 7) in second impact grid 44 and into first chute 26 where they travel downwardly until they exit the breaker through discharge opening 24.

The remaining material lumps 86 and impurities move from the second processing region into the third processing region by dropping from the second impact grid onto the third inclined scalping grizzly 46. Any predetermined size pieces 82 and smaller that are mixed in with material lumps 86 pass through openings 68 in third scalping grizzly 46 and into first chute 26. The larger lumps 86 continue to roll downwardly along third scalping grizzly 46 until they are struck by flails 72 of rotating third rotor 58. Third rotor 58 accelerates the material lumps 86 and impurities in the same direction in which they were traveling, i.e., in the direction indicated by arrow D. Lumps 86 are thrown against third impact grid 50 and are split yet again by pointed plates 76 thereon. Once again, some of the predetermined size pieces 82b pass through openings 78 (FIG. 7) in third impact grid 50 and into second chute 28. These pieces join the stream of predetermined size pieces 82b traveling through second chute 28 and pass out of discharge opening 24. Nearly all of the larger material lumps 86 will be broken after contacting third impact grid 50. However, any material lumps 86 and impurities that have not been split to a size sufficient to pass through openings 78 (FIG. 7) pass out of passageway 22 and through discharge opening 24. They may be reintroduced into the steam of material that is directed through inlet opening 18 into the first processing region.

The fact that there are at least three rotors 54, 56, 58 in hopper 10 enables the breaker to break down larger material lumps to into the desired size pieces and smaller with the rotors moving at lower speeds of rotation than in previously known machines. Furthermore, the lowered speeds cause the larger lumps of material to be fractured on the pointed plates 76 instead of being shattered, thereby reducing the quantity of fines produced by the breaker. The speeds are also typically not high enough to cause rocks, minerals and other impurities contained in the material to be split by the impact grids to a size sufficient to permit them to pass through the openings in the scalping grizzlies and impact grids. Consequently, these impurities tend to travel all the way down to the bottom of the zigzag passageway 22 through the machine where they are more easily separated from the material discharged through discharge opening 24.

As was the case with the device disclosed in U.S. Pat. No. 4,592,516, the rotational speeds of first, second and third rotors 54, 56 and 58 of the present invention are adjustable to match the particular hardness of the material 80 fed into inlet opening 18. The rotational speeds are adjusted until the larger material lumps 86 are mainly fractured instead of completely shattering or splitting into very small pieces when they strike the impact grids. If the lumps 86 are not being accelerated fast enough and are therefore not being sufficiently split by the process, the rotational speeds of the rotors is increased. If the acceleration of the material lumps is too great, then the quantity of fines being produced and impurities broken down by the process will be excessive and the rotational speeds of the rotors is reduced. The speed of the first rotor 54 is set to be sufficient to engage the large lumps of material and accelerate them toward the first impact grid 38. The speed of this first rotor 54 must be high enough to only fracture the large material lumps instead of shattering them. Essentially, the first rotor 54 is simply used to break the lumps into a more manageable size. The second rotor 56 may be rotated slightly faster than the first rotor 54 and the third rotor 58 may be rotated slightly faster than the second rotor 56. The operator sets the impact velocity of rotors 54, 56 and 58 by adjusting the speed of the drive motors. The velocity is adjusted to match the individual material seam being processed simply by turning a potentiometer dial.

The lowered speed of rotation of rotors 54, 56 and 58 relative to previously known devices has the side benefit of also reducing the friction and wear and tear on the rotors, impact grids, and other components in the system, thereby prolonging the life of the device and reducing the frequency of maintenance thereon.

The improved material breaker is preferably located and used on the site to separate and size the material immediately after being produced. This eliminates the need to transport the material, including the impurities, to a remote location and then transporting those impurities on to a dump site or pit. If a source of electrical energy is not available at the site, the electrical motors can be replaced easily by hydraulic motors run by a portable generator. Such hydraulic motors would be connected directly to the output of the rotor shafts eliminating the drive belts and associated sheaves. Likewise the unit can be modified for producing different size material pieces by replacing the inclined scalping grizzlies and impact grids with similar equipment having the desired size openings formed therein.

Accordingly, the improved material breaker construction provides an effective, safe, and efficient device which achieves all of the enumerated objectives, provides for eliminating difficulties encountered with prior devices and solves problems and obtains new results in the art.

In the device of the present invention, the inventor has recognized that the rotors can be rotated at lower speeds as each successive processing region in the breaker provides an additional opportunity for pieces of material to be fractured off of the larger lumps. Because the rotors are moving at a lower speed, the larger lumps of material are not accelerated toward the impact grids with the same velocity as they would be if the rotors were moving at higher speed. Consequently, when the larger lumps of material strike the impact grids they are fractured without producing the large quantity of particulates, or fines, as would be the case if they struck the impact grid at a higher velocity. Additionally, the lower speed rotors generate less wind blowing out of the breaker than would be the case if the rotors moved at a higher speed. Consequently, the quantity of dust blown out of the breaker is much reduced. Furthermore, the inventor has recognized that it is possible to include more than three processing regions in the breaker so that the system can be used to process much larger lumps of material than was possible in previously known devices.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is by way of an example and the invention is not limited to the exact details shown or described.

Having now described the features, discoveries and principles of the invention, the manner in which the improved material breaker construction is constructed and used, the characteristics of the construction, and the advantageous, new and useful results obtained; the new and useful structures, devices, elements, arrangement, parts, and combinations are set forth in the appended claims.

1. A material breaker comprising:
a first processing region having an input and an output, said first processing region being adapted to receive a quantity of material to be processed through the input thereof, and is adapted to discharge a quantity of processed material from the output;
a second processing region having an input and an output; wherein the input of said second processing region is disposed so as to receive processed material from the output of the first processing region; and the output of the second processing region is adapted to discharge processed material therefrom; and
a third processing region having an input and an output, wherein the input of the third processing region is disposed so as to receive processed material from the output of the second processing region, and the output of the third processing region is adapted to discharge processed material therefrom.

2. The material breaker as defined in claim 1, wherein at least one of the first, second and third processing regions includes an inclined scalping grizzly disposed proximate the input of the at least one of the first, second and third processing regions.

3. The material breaker as defined in claim 2, wherein at least one of the first, second and third processing regions includes a rotatable rotor adapted to engage the material to be processed and to accelerate it in the direction in which it is traveling between the input and output of that processing region.

4. The material breaker as defined in claim 3, wherein the rotor is disposed in the at least one of the first, second and third processing regions that includes the inclined scalping grizzly and the rotor is disposed so as to engage materials moving down the inclined scalping grizzly.

5. The material breaker as defined in claim 4, wherein at least one of the first, second and third processing regions includes an impact grid having a plurality of points extending outwardly therefrom.

6. The material breaker as defined in claim 5, wherein the impact grid is disposed in the at least one of the first, second and third processing regions that includes the scalping grizzly and the rotor, and the impact grid is disposed intermediate the rotor and the output of the at least one of the first, second and third processing regions.

7. The material breaker as defined in claim 1, wherein the first, second and third processing regions are disposed in series relative to each other.

8. The material breaker as defined in claim 7, wherein the first, second and third processing regions are disposed vertically one above the other.

9. The material breaker as defined in claim 1, wherein:
the first processing region includes:
a first scalping grizzly including a plurality of openings through which predetermined size materials will pass;
a first rotor disposed proximate the first scalping grizzly, said first rotor being rotatable at a first speed and being adapted to engage materials traveling down the first scalping grizzly and accelerate them in the same direction in which they were traveling;
a first impact grid positioned so as to be impacted by the materials accelerated by the first rotor; said first impact grid including a plurality of openings through which predetermined size materials will pass; and
the second processing region includes:
a second scalping grizzly including a plurality of openings through which predetermined size materials will pass;
a second rotor disposed proximate the second scalping grizzly, said second rotor being rotatable at a second speed and being adapted to engage materials traveling down the second scalping grizzly and accelerate them in the same direction in which they were traveling;
a second impact grid positioned so as to be impacted by the materials accelerated by the second rotor; said second impact grid including a plurality of openings through which predetermined size materials will pass and
the third processing region includes:
a third scalping grizzly including a plurality of openings through which predetermined size materials may pass;
a third rotor disposed proximate the third scalping grizzly, said third rotor being rotatable at a third speed and being adapted to engage materials traveling down the third scalping grizzly and accelerate them in the same direction in which they were traveling; and
a third impact grid positioned so as to be impacted by the materials accelerated by the third rotor; said third impact grid including a plurality of openings through which predetermined size materials will pass.

10. The material breaker as defined in claim 7, further comprising:
at least one additional processing region having an input and an output, wherein the input of the additional processing region is disposed so as to receive processed materials from the output of the third processing region, and the output of the additional processing region is adapted to discharge processed materials therefrom.

11. The material breaker as defined in claim 10, wherein the additional processing region includes:
an additional scalping grizzly having a plurality of openings through which predetermined size materials will pass;
an additional rotor disposed proximate the additional scalping grizzly, said additional rotor being rotatable and being adapted to engage materials traveling down the additional scalping grizzly to accelerate them in the same direction in which they were traveling; and
an additional impact grid positioned so as to be impacted by the materials accelerated by the additional rotor; said additional impact grid including a plurality of openings through which predetermined size materials will pass.

12. A material breaker for breaking larger lumps of material into smaller pieces of material; wherein said breaker comprises a machine having:
a first processing region;
a second processing region disposed in series with the first processing region; and
a third processing region disposed in series with the second processing region; and wherein each of the first, second and third processing regions includes:
an inclined scalping grizzly adapted to move the lumps of material therealong under influence of gravity; said scalping grizzly defining a plurality of openings therein that permit pieces of material of a predetermined size and smaller to pass therethrough;
a rotatable rotor that is adapted to engage the lumps of material traveling down the scalping grizzly and to accelerate them in the direction in which they were traveling; and
an impact grid positioned so as to be in the pathway of the accelerated lumps of material; wherein the impact grid includes a plurality of points projecting outwardly away therefrom, said points being adapted to fracture the lumps of material into smaller pieces; and wherein said impact grid further including a plurality of openings disposed between the points that permit pieces of the predetermined size and smaller to pass therethrough.

13. The material breaker as defined in claim 12, further comprising at least one additional processing region disposed in the breaker in series with the third processing region; and wherein the at least one additional processing region includes:
an additional scalping grizzly disposed to received processed materials from the third processing region; said additional scalping grizzly including a plurality of openings through which pieces of material of the predetermined size and smaller will pass;
an additional rotor disposed proximate the additional scalping grizzly, said additional rotor being rotatable and being adapted to engage the lumps of material traveling down the additional scalping grizzly and accelerate them in the same direction in which they were traveling; and
an additional impact grid positioned so as to be impacted by the materials accelerated by the additional rotor; said additional impact grid including an additional plurality of points adapted to fracture lumps of material accelerating toward them, and further including a plurality of openings defined between said points and through which pieces of material of a predetermined size and smaller will pass.

14. A method of producing material pieces of a predetermined size comprising the steps of:
providing a machine that includes a first processing region, a second processing region; and a third processing region operationally disposed in series with each other; wherein each of the first, second and third processing regions includes an inclined scalping grizzly, a rotor disposed proximate the scalping grizzly and an impact grid disposed a distance away from the rotor; and wherein the method further includes the steps of:
processing the material sequentially through each one of the first, second and third processing regions;
passing the processed material from the first processing region into the second processing region and from the second processing region into the third processing region;
passing the processed material at the end of the third processing region through a discharge opening; and
removing pieces of material of a predetermined size and smaller from each of the first and second processing regions before the material is passed on to the next one of the second and third processing regions.

15. The method as defined in claim 14, wherein the step of processing the material comprises the steps of:
moving the lumps of material down the inclined scalping grizzly of the first processing region under the influence of gravity;
rotating the rotor in the first processing region so that at least one flail thereof engages the lumps of material traveling down the inclined scalping grizzly;
accelerating the engaged lumps of material by way of the flail in the direction in which they were traveling;
positioning the impact grid of the first processing region in the path of the accelerated lumps of material; whereby the lumps of material are fractured into smaller pieces by a plurality of points on the impact grid and a plurality of pieces of material of a predetermined size and smaller pass through a plurality of openings in the impact grid of the first processing region.

16. The method as defined in claim 15, further comprising the steps of:
moving the fractured lumps of material that are larger than the predetermined size from the impact grid of the first processing region onto the inclined scalping grizzly of the second processing region;
moving the fractured lumps of material down the inclined scalping grizzly of the second processing region under influence of gravity;
rotating the rotor in the second processing region so that at least one flail thereof engages the fractured lumps of material traveling down the inclined scalping grizzly in this second processing region;
accelerating the engaged fractured lumps of material by way of the flail of the second rotor in the direction in which they were traveling;
positioning the impact grid of the second processing region in the path of the accelerated lumps of material; whereby the fractured lumps of material are broken into smaller pieces by a plurality of points on the impact grid in the second processing region; and a plurality of pieces of material of a predetermined size and smaller pass through a plurality of openings in the impact grid of the second processing region.

17. The method as defined in claim 16, further comprising the steps of:
moving the further fractured lumps of material that are larger than the predetermined size from the impact grid of the second processing region onto the inclined scalping grizzly of the third processing region;
moving the further fractured lumps of material down the inclined scalping grizzly of the third processing region under influence of gravity;
rotating the rotor in the third processing region so that at least one flail thereof engages the further fractured lumps of material traveling down the inclined scalping grizzly in the third processing region;
accelerating the engaged further fractured lumps of material by way of the flail of the third rotor in the direction in which they were traveling;
positioning the impact grid of the third processing region in the path of the accelerated lumps of material; whereby the further fractured lumps of material are broken into yet smaller pieces by a plurality of points on the impact grid in the third processing region; and a plurality of pieces of material of a predetermined size and smaller pass through a plurality of openings in the impact grid of the third processing region.

18. The method as defined in claim 17, further comprising the step of:
gathering together the pieces of material of a predetermined size and smaller that have been removed from each of the first, second and third processing regions.

19. The method as defined in claim 18, further comprising the step of:
moving the further fractured lumps of material that are larger than the predetermined size through a discharge chute proximate the impact grid of the third processing region; and
sending the lumps of further fractured material that exit the discharge chute for additional processing.

20. The method as defined in claim 14, further comprising the step of:
depositing a quantity of lumps of material of greater than 2″ in diameter into a hopper disposed above the first processing region, wherein the hopper includes a chute that drops the lumps of material onto the scalping grizzly disposed at a top end of the first processing region.
